(19) United States
(12) Patent Application Publication
(10) Pub. No.: US 2004/0217068 A1
(43) Pub. Date: Nov. 4, 2004

(54) Method and system for treating water

(76) Inventor: Alan Kirby, Lethbridge (CA)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(21) Appl. No.: 10/763,586

(22) Filed: Jan. 23, 2004

Related U.S. Application Data
(63) Continuation of application No. PCT/CA03/00463, filed on Apr. 3, 2003.
(60) Provisional application No. 60/443,496, filed on Jan. 28, 2003.

(51) Int. Cl. C02F 1/78

(52) U.S. Cl. 210/760

(57) ABSTRACT

A method of treating an aqueous fluid with a fluid reagent is described comprising providing an untreated aqueous fluid stream having at least one contaminant, combining the untreated aqueous fluid stream with a portion of a treated aqueous fluid stream to produce a treatment fluid stream having at least one contaminant, and effecting a reduction in the fluid pressure of the treatment fluid stream sufficient to effect a fluid pressure differential between the treatment fluid stream and a source of a fluid reagent to thereby induce introduction of the fluid reagent from the source of the fluid reagent to the treatment fluid stream, such introduction of the fluid reagent to the treatment fluid stream effects reaction of at least a portion of the at least one contaminant in the treatment fluid stream with at least a portion of the fluid reagent to produce the treated aqueous fluid stream.

A method of controlling a surface area of an interface between a liquid and a gas, the gas and the liquid being contained in a vessel, the liquid having at least one contaminant and at least one gaseous reagent for reacting with the at least one contaminant to form a reaction product, the gas being disposed above the liquid to define an amount of gas on a mass basis, the interface permitting the at least one gaseous reagent or reaction product to migrate from the liquid to the gas, comprising measuring a high interface surface area indication, and controlling the amount of gas in response to the high interface surface area indication.

### FIELD OF THE INVENTION

The present invention relates generally to treating water and particularly to enhancing contact between a contaminant treatment additive and contaminants in such water.

### BACKGROUND OF THE INVENTION

Ozone (O₃) is a naturally occurring allotrope of oxygen having the highest oxidation potential of all commercially available oxidants. Ozone is used for treatment of organically and biologically contaminated water. Ozone effects oxidation of such contaminants, thereby inactivating viruses, killing bacteria, removing other undesirable contaminants.

Inorganic and organic contaminants in water will be oxidized by ozone more rapidly and at lower concentrations than by other chemicals, such that ozone has been used in potable water treatment for many years. However, ozonation for the disinfecting of water commonly suffers from inadequate contact between the ozone introduced into the water system and the contaminants being oxidized, resulting in reduced disinfectant action. Key to the use of ozone for disinfecting water is the transfer of ozone from a gas into solution and the effective removal of both the residual and entrained gas from the treated water. Traditional means for increasing contact have concentrated on introducing larger quantities of ozone by deploying larger ozone generators that disadvantageously cost more to purchase and to operate. More recently, patented Mazzei® venturi-type injectors have been successfully used to cause more ozone to enter aqueous solution. Injecting the ozone gas into water streams through such injectors results in a very high percentage of transfer of ozone into the water because of the creation of “micro-bubbles” of ozone that are aggressively mixed into the water stream. The huge number of very small bubbles present a large total surface area over which ozone may transfer very effectively into the water.

Even using this improved means of injection, conventional systems, such as those described in U.S. Pat. No. 5,674,312 issued to GDT Corporation on 7 Oct. 1997 (“312”), merely use a feed water pump to effect flow of water through the Mazzei® venturi-type injector to efficiently introduce ozone into the water stream. While some embodiments rely on the length of the water conduit to ensure sufficient time for the ozone to remain resident in the water stream, typically, the partially treated stream then flows into a reservoir or “contact tank” (a.k.a. Reaction Vessel) in which the dynamic mixing that occurred at the injector is enhanced. The tank provides time and space for the ozone to come in contact with and oxidize water-borne contaminants. The next active element of a prior art system is a gas separator that allows ozone to be removed from the treated water. Various means are employed by conventional systems to separate entrained ozone from water. In some applications it is necessary to quickly force the gas out by centrifuge or otherwise, while in other applications the system demand permits waiting for the gas to passively rise out of the water. A gas relief valve is then used to release the separated ozone and other gases for treatment, reuse or venting. A back pressure control valve maintains a defined pressure in order to maximize the treatment process and minimize operating costs. In fact, to some extent, 312 teaches away from the more efficient use of ozone in its use of more powerful separation technology that solves one problem of the prior art by removing residual ozone wasted when more is entrained than can be used.

A further disadvantage of even those conventional systems that do permit the release of gas (including reaction by-products and residual ozone) is that they use mechanical pressure actuated gas-off valves that operate more frequently, in shorter bursts, such that they can become clogged with floatables that separate out of the liquid. If the gas-off valve is blocked, then the tank can fill with gas, pushing water out of the contact tank and thereby reducing treatment.

The prior art in the water treatment industry has concentrated on teaching variations on means for wastefully introducing greater quantities of ozone together with contact tanks that increase the opportunity for ozone to contact contaminants. Therefore, it is desirable to provide a solution to the need to use ozone and other additives more effectively, such that for example, the same amount of ozone can treat a given volume of water in less time, or less ozone can treat that same volume of water in the same time.

### SUMMARY OF THE INVENTION

The present invention provides a method of treating an aqueous fluid with a fluid reagent comprising providing an untreated aqueous fluid stream having at least one contaminant combining the untreated aqueous fluid stream with a portion of a treated aqueous fluid stream to produce a treatment fluid stream having at least one contaminant and effecting a reduction in the fluid pressure of the treatment fluid stream sufficient to effect a fluid pressure differential between the treatment fluid stream and a source of a fluid reagent to thereby induce introduction of the fluid reagent from the source of the fluid reagent to the treatment fluid stream, such introduction of the fluid reagent to the treatment fluid stream effects reaction of at least a portion of the at least one contaminant in the treatment fluid stream with at least a portion of the fluid reagent to produce the treated aqueous fluid stream.

In another aspect, the reagent includes ozone.

In another aspect, the invention provides a system for treating an aqueous fluid with a fluid reagent comprising means for introducing an untreated aqueous fluid stream having at least one contaminant, means for combining the untreated aqueous fluid stream with a portion of a treated aqueous fluid stream to produce a treatment fluid stream having at least one contaminant, and means for effecting a reduction in the fluid pressure of the treatment fluid stream sufficient to effect a fluid pressure differential between the treatment fluid stream and a source of a fluid reagent to thereby induce introduction of the fluid reagent from the source of the fluid reagent to the treatment fluid stream, such introduction of the fluid reagent to the treatment fluid stream effects reaction of at least a portion of the at least one contaminant in the treatment fluid stream with at least a portion of the fluid reagent to produce the treated aqueous fluid stream.

In another aspect, the means for effecting a reduction in the fluid pressure is a venturi-type injector.

In a further aspect, the invention provides a method of controlling a surface area of an interface between a liquid and a gas, the gas and the liquid being contained in a vessel, the liquid having at least one contaminant and at least one gaseous reagent for reacting with the at least one contaminant to form a reaction product, the gas being disposed above the liquid to define an amount of gas on a mass basis, the interface permitting the at least one gaseous reagent or reaction product to migrate from the liquid to the gas, comprising measuring a high interface surface area indication, and controlling the amount of gas in response to the high interface surface area indication.

In yet another aspect, the amount of gas is controlled by discharging at least a portion of the gas from the vessel.

In yet another aspect, the high surface area indication is provided when the interface is disposed at a level in the vessel below which the surface area of the interface would increase by an undesirable amount.

In yet another aspect, the invention provides a system configured for containing a liquid and a gas, the liquid having at least one contaminant and at least one gaseous reagent for reacting with the at least one contaminant to form a reaction product, the gas being disposed over the liquid such that an interface is defined between the liquid and the gas, the interface permitting the at least one gaseous reagent or reaction product to migrate from the liquid to the gas, the system comprising a vessel including a first portion defining a first space, and a second portion defining a second space, the second portion merging with the first portion, the second space being disposed below the first space, wherein the rate of increase of cross-sectional area of the first space with respect to height is less than the rate of increase of cross-sectional area of the second space with respect to height, and a controller, communicating with the first space for receiving a low interface level indication in the first space, and configured to effect a discharge of at least a portion of the gas from the first space in response to the low interface level indication to prevent the interface from moving from the first space to the second space.

In a further aspect, the rate of increase of cross-sectional area of the first space with respect to height in a downwardly direction is less than the rate of increase of cross-sectional area of the second space with respect to height in a downwardly direction.

In an aspect, the prevent invention provides the first portion of the vessel is defined by an elongated chamber.

In a further aspect, a system configured for containing a liquid and a gas, the liquid having at least one contaminant and at least one gaseous reagent for reacting with the at least one contaminant to form a reaction product, the gas being disposed over the liquid such that an interface is defined between the liquid and the gas, the interface permitting the at least one gaseous reagent or reaction product to migrate from the liquid to the gas, the system comprising a vessel comprising a first portion defining a first space, and a second portion defining a second space, the second portion merging with the first portion, the second space being disposed below the first space, such that the rate of increase of cross-sectional area of the interface with respect to height when the interface is disposed in the first space is less than the rate of increase of cross-sectional area of the interface with respect to height when the interface is disposed in the second space, and, a controller, communicating with the first space for receiving a low interface level indication in the first space, and configured to effect a discharge of at least a portion of the gas from the first space in response to the low interface level indication to prevent the interface from moving from the first space to the second space.

In yet another aspect, the rate of increase of cross-sectional area of the interface with respect to height in a downwardly direction when the interface is disposed in the first space is less than the rate of increase of cross-sectional area of the interface with respect to height in a downwardly direction when the interface is disposed in the second space.

In yet a further aspect, the first portion of the vessel is defined by an elongated chamber.

The present invention provides a diffuser for redirecting an introduced fluid stream from a vessel inlet towards a bottom surface of the vessel, the diffuser comprising a hollow body having a sidewall for defining an interior configured to receive the fluid stream, the sidewall having an interior surface and an exterior surface, a connector fixed to the sidewall for coupling the body to the vessel inlet, the connector for providing fluid communication of the fluid stream from the vessel inlet and into the interior of the body, an end wall connected to the sidewall and located oppositely to the position of the connector, the end wall for restricting fluid communication of the fluid stream from the interior and into the reservoir, and at least one slot extending through the sidewall, the slot having an entrance located on the interior surface, an exit located on the exterior surface, and a passageway for effecting fluid communication between the entrance and the exit, the passageway being situated along an axis configured at an acute angle with respect to the bottom surface of the vessel, wherein the passageway directs the fluid stream from the interior of the body and towards the bottom surface of the vessel.

In yet a further aspect of the invention, the diffuser further comprising a plurality of the slots extending through the sidewall, each of the slots defining an arc extending around a portion of a periphery of the sidewall of the body.

In another aspect, each of the slots redirects a portion of the fluid stream as a redirected fluid jet towards the bottom surface of the vessel, each of the redirected fluid jets providing a fan shaped flow geometry of the respective fluid portion.

In yet another aspect, the diffuser further comprising a total cross sectional area of the exits of the slots is less than the cross sectional area of the vessel inlet, wherein the difference in the cross sectional areas provides for a fluid pressure differential between the fluid contained in the interior of the body and the fluid contained in the vessel.

In a further aspect, the diffuser further comprising a hole located in the end wall for allowing accumulated gases in the interior of the body to escape into the vessel while promoting the redirection of the fluid stream through the slot.

The present invention provides the diffuser wherein the vessel inlet is located on the bottom surface of the tank.

The present invention also provides the diffuser wherein the body is configured for orientation with the bottom surface such that the exterior surface of the sidewall is substantially perpendicular with respect to the bottom surface of the vessel.

In yet another aspect, a diffuser configured for mounting to a vessel having an interior bottom surface, the diffuser comprising a conduit defining a fluid passage for receiving a gas-containing liquid introduced through a vessel inlet, and at least one slot defining a fluid passageway for effecting fluid communication between the fluid passage and fluid within the vessel, the passageway having an axis disposed at an acute angle relative to the interior bottom surface of the vessel.

In yet another aspect, each of the at least one slot defines an arc extending around a portion of a periphery of the conduit.

In a further aspect, each of the at least one slot redirects a portion of the fluid stream as a redirected fluid jet towards the bottom surface of the vessel, each of the redirected fluid jets providing a fan shaped flow geometry of the respective fluid portion.

In yet a further aspect, the vessel inlet is located on the bottom surface of the vessel.

The present invention provides a method of treating an aqueous fluid with a fluid reagent comprising providing an aqueous fluid stream having at least one contaminant effecting a reduction in the fluid pressure of the aqueous fluid stream sufficient to effect a fluid pressure differential between the aqueous fluid stream and a source of a fluid reagent to thereby induce introduction of the fluid reagent from the source of the fluid reagent to the aqueous fluid stream, such introduction of the fluid reagent to the aqueous fluid stream effects reaction of at least a portion of the at least one contaminant in the aqueous fluid stream with at least a portion of the fluid reagent to produce a treated aqueous fluid stream, and delivering the treated aqueous fluid stream to a motive means, the motive means contributing to effecting the reduction in fluid pressure of the aqueous fluid stream.

In a further aspect, the reagent includes ozone.

In yet another aspect, a system for treating an aqueous fluid with a fluid reagent comprising means for introducing an aqueous fluid stream having at least one contaminant, means for effecting a reduction in the fluid pressure of the aqueous fluid stream sufficient to effect a fluid pressure differential between the aqueous fluid stream and a source of a fluid reagent to thereby induce introduction of the fluid reagent from the source of the fluid reagent to the aqueous fluid stream, such introduction of the fluid reagent to the aqueous fluid stream effects reaction of at least a portion of the at least one contaminant in the aqueous fluid stream with at least a portion of the fluid reagent to produce a treated aqueous fluid stream, and a motive means for receiving the treated aqueous fluid stream, the motive means contributing to effecting the reduction in fluid pressure of the aqueous fluid stream.

In a further aspect, the means for effecting a reduction in the fluid pressure is a venturi-type injector.

### BRIEF DESCRIPTION OF THE DRAWINGS

The present invention, in order to be easily understood and practised, is set out in the following non-limiting examples shown in the accompanying drawings, in which:

FIG. 1 is a block diagram of one embodiment of the system of the present invention illustrating the combination of a novel arrangement of known elements with the novel apparatus of the present invention;

FIG. 2 is a block diagram of the embodiment of the system illustrated in FIG. 1, but shown without inflow or discharge and while in re-circulation mode;

FIG. 3 is an illustration of one embodiment of the mixer apparatus of the present invention;

FIG. 3b is an alternative embodiment of the mixer apparatus of FIG. 3a;

FIG. 3c is a section B-B view of the mixer apparatus of FIG. 3b;

FIG. 3d is a section A-A view of the mixer apparatus of FIG. 3b;

FIG. 3e is a further embodiment of the mixer apparatus of FIG. 3a;

FIG. 4 is an illustration of one embodiment of the evacuation chamber apparatus of the present invention.

FIG. 5 is an illustration of one embodiment of the method of the present invention;

FIG. 6 is an illustration of one embodiment of the ozone generator flooding prevention apparatus of the present invention;

FIG. 7 is a block diagram of one embodiment of the enhanced blending apparatus of the present invention.

FIG. 8 is a block diagram of one embodiment of the system of the present invention combining the enhanced blending apparatus shown in FIG. 7 with a reservoir including the mixer apparatus shown in FIG. 3.

FIG. 9 is a block diagram of one embodiment of the system of the present invention combining a reservoir including the mixer apparatus shown in FIG. 3 with the evacuation chamber apparatus shown in FIG. 4.

FIG. 10 is a block diagram of one embodiment of the re-circulation apparatus of the present invention.

FIG. 11 is a side view of one embodiment of the system of the present invention illustrating the combination of a novel arrangement of known elements (including an ozone generation apparatus) with the novel apparatus of the present invention.

FIG. 12 is a top view of one embodiment of the system of the present invention illustrating the combination of a novel arrangement of known elements with the novel apparatus of the present invention.

### DETAILED DESCRIPTION OF THE PREFERRED EMBODIMENT

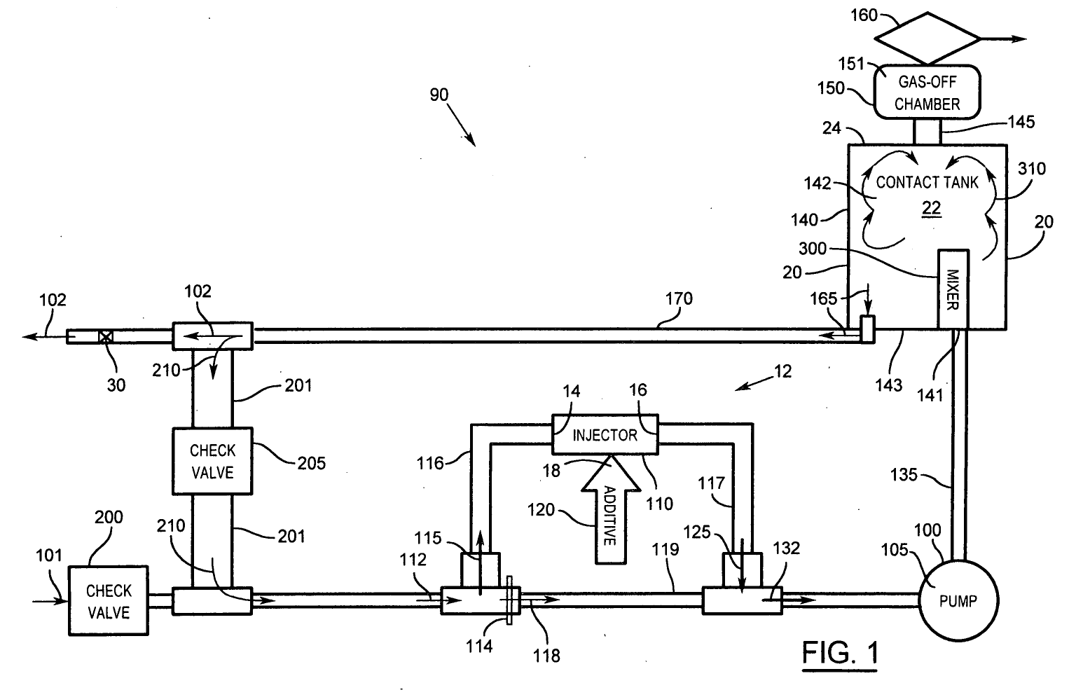

Reference is to be had to FIGS. 1-12 in which identical reference numbers identify similar components.

Treatment herein is understood to include all water processing that achieves improvements to the taste, odor, colour, or turbidity of the volume of water treated. Specifically, disinfection against micro-organisms (e.g. bacterial or viral), the precipitation or agglomeration of solids (e.g. minerals) to make subsequent filtration more effective, and the reduction of the adverse effects of other forms of contaminant for the purpose of making water better for consumption are objectives of the embodiments of the invention described herein. Although according to a preferred embodiment of the system of the present invention the additive ozone gas is used to treat water in accordance with the method of the present invention, it is contemplated that other gases (e.g. bromine or chlorine) suitable for use in treating water may be the additive used in the present invention. It is further contemplated that a variety of liquids (e.g. chlorine or solutions of silver salt) may be the additive used with the present invention. A person of skill in the art would understand that the end use of the treated water will be a factor in determining which additive to use and in what quantity. The blending ratios and other system settings will similarly be affected by the choice and form of the additive. However, the principles of enhanced blending, the directed swirling introduction of an enriched water stream into a body of water under treatment, the delayed separation of un-reacted additive (via the suppression of spontaneous separation) from water, and the re-circulation of water under treatment are all advantageous and applicable to use with different additives in systems engineered for a wide range (residential, commercial, industrial) of supply capacity. A person of skill in the art would further understand that the element (as well as process conditions such as the temperature and pressure) for separating reaction byproducts and residual additive from water will need to be adapted to the characteristics of the specific additive, particularly when introduced in liquid form.

Referring to FIG. 1, there is illustrated an embodiment of water treatment system 90 of the present invention. The water treatment system 90 includes a fluid reagent injection assembly 12 to effect treatment of an aqueous fluid stream including one or more contaminants. A pump 105 is provided to effect flow of the treated aqueous fluid stream. The treated aqueous fluid stream is delivered by the pump 105 to a contact tank 140. The contact tank 140 provides the treated aqueous fluid with sufficient residence time to effect reaction between the contaminant(s) and the fluid reagent to effect depletion of the contaminant(s). When there is a demand for treated water from a user, a valve 10 downstream of the contact tank 140 is opened, and the treated aqueous fluid is discharged from the contact tank 140. A portion 102 of the discharge 170 is delivered to the user, and a further portion 210 is recirculated through the system. The term “fluid”, as is used herein, is intended to include liquids as well as liquids having dissolved and/or entrained gases.

The fluid reagent injection assembly 12 induces injection of a fluid reagent to a treatment fluid stream 112. In this respect, the fluid reagent injection assembly includes a means 110 for inducing introduction of the fluid reagent to the treatment fluid stream 112. As an example, the means 110 for inducing can be a venturi-type, differential pressure injector, such as a Mazzei™ injector.

The fluid reagent injection assembly 12 receives a treatment fluid stream 112 comprising an untreated aqueous liquid stream 101 and a portion 210 of a treated aqueous fluid stream. The untreated aqueous fluid stream 101 is derived from a source of untreated aqueous fluid. In one embodiment, the untreated aqueous fluid comprises substantially water and at least one contaminant.

The treatment fluid stream 112 is delivered to the fluid reagent injection assembly 12. In the illustrated embodiment, the treatment fluid stream 112 becomes divided in the fluid reagent injection assembly into a treatment stream 115 and a bypass stream 118. A flow restrictor 114 is provided in the flow path of the bypass stream 118 with a view to effecting close to a desired division of the treatment fluid stream 112 between the treatment stream 115 and the bypass stream 118. The bypass stream 118 is provided in cases where the anticipated flow rate of the treatment fluid stream 112 exceeds the capacity of the injector 110. In cases where the anticipated flow rate of the treatment fluid stream 112 will not exceed the capacity of the injector 110, the entire treatment fluid stream 112 can be delivered to the injector 110, without diverting a portion of the treatment fluid stream 112 as the bypass stream 118.

The treatment stream 115 is delivered to the injector 110. The injector 110 includes a treatment fluid inlet 14, a treatment fluid outlet 16, and a suction inlet 18. The treatment fluid inlet 14 is fluidly coupled to the source of untreated aqueous fluid and receives the treatment stream 115. The suction inlet 118 is fluidly coupled to the source of fluid reagent 120 to the treatment fluid 115 flowing through the injector 110. The treated fluid outlet 118 is fluidly coupled to the suction of the pump 105. In the embodiment illustrated, the treated fluid discharging from the outlet 16 combines with the bypass stream 118 before being delivered to the pump 105.

The treatment stream 115 flowing through the injector 110 induces delivery of the fluid reagent and its introduction to the treatment fluid stream 115. In particular, this induction is effected by way of suction of the fluid reagent. The injector 110 includes a convergent nozzle portion, a divergent nozzle portion, and a nozzle throat portion disposed between the convergent and divergent nozzle portions. The treatment fluid stream entering the injector through the treatment fluid inlet flows through the convergent nozzle portion. The flow through the convergent nozzle portion accelerates and experiences a concomitant reduction in fluid pressure. The flow entering the nozzle throat portion is of sufficiently low fluid pressure such that a partial vacuum is created to induce delivery of the fluid reagent. The fluid reagent becomes entrained in the treatment stream 115 to form a treated aqueous fluid stream 117. The treated aqueous fluid stream 117 flows through the divergent nozzle portion, resulting in a reduction in velocity with a concomitant increase in fluid pressure before discharge through the treatment fluid outlet 16.

Introduction of the fluid reagent to the treatment stream 115 effects reaction of at least a portion of the at least one contaminant with a portion of the fluid reagent to produce the treated aqueous fluid stream 117. The reaction does not occur instantaneously, but rather occurs over a period of time, as the fluid stream flows through the system. The rate of reaction is limited by the reaction kinetics of the subject reaction and the hydraulic conditions of the stream, which affect frequency of contact between the reagent and the contaminant. The term “treated aqueous fluid stream” refers to the fluid stream after having being injected with the fluid reagent, and refers to the fluid stream at any point downstream of the point where injection is effected, and does not refer to a condition of the fluid stream wherein the fluid stream is depleted of contaminants to any certain specific degree.

A pump 105 is fluidly coupled to the injector outlet 16, to receive the treated aqueous fluid stream. The pump 105 effects propulsion of the treated aqueous fluid stream by transferring mechanical energy into kinetic energy of the treated aqueous fluid stream.

The pump 100 receives the treated aqueous fluid. The pump 100 transfers mechanical energy of a propulsion mechanism 105, such as an impeller, into kinetic energy of the stream 101. Advantageously, by placing pump 100 in close proximity to and downstream of a location at which additive 120 is introduced into water stream 115 using injector 110, the propulsion mechanism 105 aggressively mixes additive enriched stream 125 with source water bypass stream 118 while acting on combined stream 132 to propel it through a conduit 135 into a contact tank 140. The aggressive mixing to blend streams 118 and 125 includes a shearing action by propulsion mechanism 105 on the units (typically bubbles or droplets) of additive 120, which (in addition to any enhancement of blending resulting from the action of injector 110) advantageously further enhances blending, by causing more additive to enter solution by further breaking said units of additive 120 into a larger number of smaller units of additive 120 resulting in a greater total surface area of (the given quantity of) additive 120 making contact with the stream of water in which it is entrained. This greater contact surface between the blended fluids immediately facilitates contact between additive 120 and contaminants in the stream of water being treated by system 90 such that treatment continues inside conduit 135. As set out in greater detail below, the larger number of more completely blended smaller units of additive also results in a more uniform density of blended fluid, reducing the risk of cavitation.

The pump also homogenizes the fluid reagent (i.e. oxidizing gas) and increases the dissolved gases into the water by way of pump head pressure. This is because the head pressure of the pump is greater than the pressure at the discharge and the suction.

It is to be understood that injecting additive immediately upstream of a blending device (e.g. the_circulation pump 100) necessitates the use of devices manufactured from suitable materials. When ozone gas is used as the additive the net result is more efficient transfer of ozone into the liquid phase. Placing the circulation pump 100 in close proximity to and immediately downstream of the venturi-type injector 110, advantageously also ensures that there is adequate suction at the injector 110 regardless of the quantity of water being drawn through the system 90, such that the injector 110 is more efficient and delivers better performance over a wider range of source water flow and pressure. Further, in the presence of a re-circulation path for water in the system 90, water from the contact tank 140 helps keep the pump 100 primed, advantageously both reducing the risk of cavitation and ensuring that there is a flow of water through the injector 110 such that additive is continuously being drawn into the water stream until the pump 100 is switched off by a controller in response to a high pressure indication in the system 90. Extra circulation time after chamber filling advantageously provides more opportunity for contact between the ozone and contaminants in the water.

Cavitation is the formation of cavities of gas in a liquid being pumped. Entrained gas bubbles compress or collapse as they pass from the inlet of the pump to the higher pressure side of the impeller adjacent the outlet, making it harder to push a gas entrained liquid through a pump. It results in: loss of capacity and head (pressure), reduced efficiency, increased noise & vibration, and damage to pump components (as cavities or bubbles collapse when they pass into higher pressure regions). Cavities form in a liquid under different conditions including: vaporization, gas (e.g. air) ingestion, internal re-circulation, and flow turbulence. A typical centrifugal pump handles 0.5% air by volume in the liquid being pumped, but can suffer significant damage when that parameter increases to 6%, however the main effect of gas ingestion is typically loss of capacity, rather than damage to the impeller or casing. Air and other gases enter a system in several ways that include: through seals, valves, flanges, bypass lines positioned too close to the suction inlet, loss of prime, and vortexing fluid at the inlet. Gas is of lower density than the liquid in which it is entrained, such that when gas is present in larger units (i.e. bubbles) the blended fluid has significant variations in density. Since pumping is an essentially mechanical operation according to which the pumping mechanism (e.g. impeller) applies force to units of the fluid being pumped, as the impeller contacts units of liquid it is better able to impart movement than when it contacts units gas. The larger the units of gas the less effective the pumping action will be. The less uniform the distribution of units of gas the more sporadic the pumping action will be resulting in a sputtering unstable throughput. Since the system of the present invention includes the injection of gas, the risk of cavitation is increased in pumps downstream of the injector, such that off-setting action is required.

Two elements of the present invention as embodied in system 90 each resist cavitation, and when these elements are combined they virtually eliminate cavitation during normal operation. First, fluid access (both outlet and inlet) to contact tank 140 is located at or near its base 143 and the circulation pump 100 inlet is located below the water level inside tank 140, advantageously ensuring that pump 100 is always fully primed with treated water through the re-circulation path. Second, by shearing the injected gas bubbles to an even smaller size than the micro-bubbles (that a venturi-type injector can create) while aggressively blending (effectively homogenizing) those bubbles into the liquid, the uniformity of density of the blended fluid being pumped is improved—since, for a given quantity of additive gas injected into the water, the resulting larger number of more evenly distributed bubbles comprises a much more uniform density of the fluid permitting smoother, quieter, more effective pump operation.

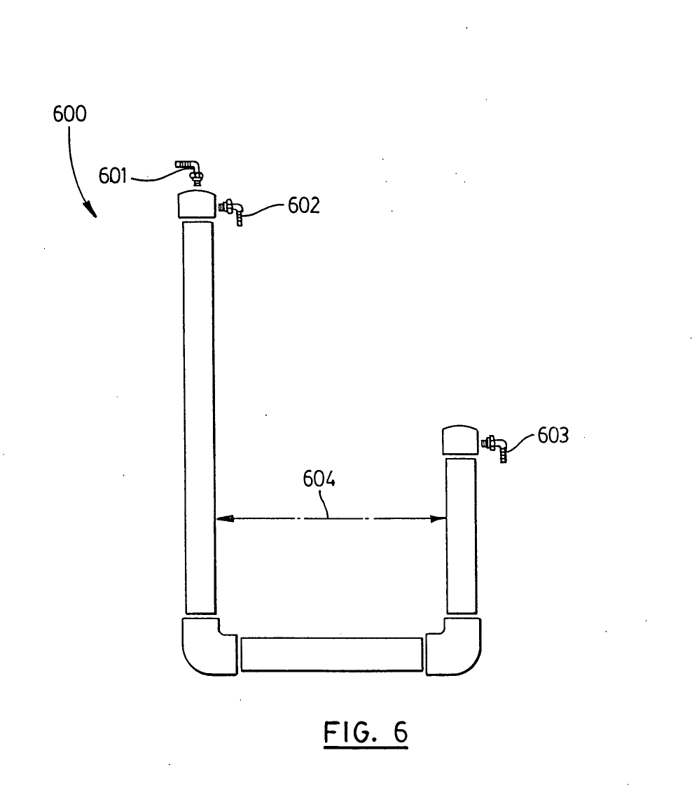

The shearing action and enhanced blending result in more efficient use of the ozone introduced to the stream. Since of the total quantity of ozone supplied to the injection assembly for introduction to the water stream, a greater percentage of it actually enters aqueous solution and, once in solution, the smaller bubble size results in greater surface area for contact—more treatment results from less ozone. Advantageously system 90 substantially increases the residual dissolved oxygen (D.O.) content of water. For example, in tests of system 90 the D.O. level in the effluent yielded a dissolved oxygen level of 13.63 mg/L measured at an atmospheric pressure of 776 mmHg and a temperature of 16.8 degrees Celsius (temperature and pressure both affect the maximum solubility of oxygen in water), at which environmental conditions a person of skill in the art would realize that 9.9 mg/L is a normal D.O (shown in chart of FIG. 6). Tests were conducted using an Accumet AR40 dissolved oxygen meter and self-stirring probe.

The contact tank 140 is fluidly coupled to the discharge of the pump to receive the treated aqueous fluid stream being discharged from the pump 105. The contact tank 140 is configured to contain a volume of the treated aqueous fluid and provides sufficient time for contact between the fluid reagent and the at least one contaminant in order to effect a desired depletion of the at least one contaminant by reaction with the fluid reagent.

Stream 132 enters tank 140 via inlet 141 at its base, and through mixer 300. Mixer 30 is configured to create secondary current 310 inside tank 140 for the purpose of increasing the contact time between additive 120 and the water comprising stream 132 that joins the fluid 142 inside tank 140. When using ozone as additive 120, although industry standards suggest a contact time of 4 minutes, the combination of the smaller units (typically bubbles) of additive 120 (hence a slower rise time inside tank 140), the downward deflecting action of mixer 300, and the enhanced circulation resulting from convention current 310, permit contact time to more than double such that a smaller quantity of additive can contact more water. By keeping tank 140 full of water under treatment, when fluid entering through mixer 300 is caught up in secondary current 310, the fluid is driven to the inside surface of the top of tank 140 against which surface it reflects downward for further circulation during which further contact between additive 120 and any contaminants remaining in fluid 142 is facilitated, thereby enhancing treatment.

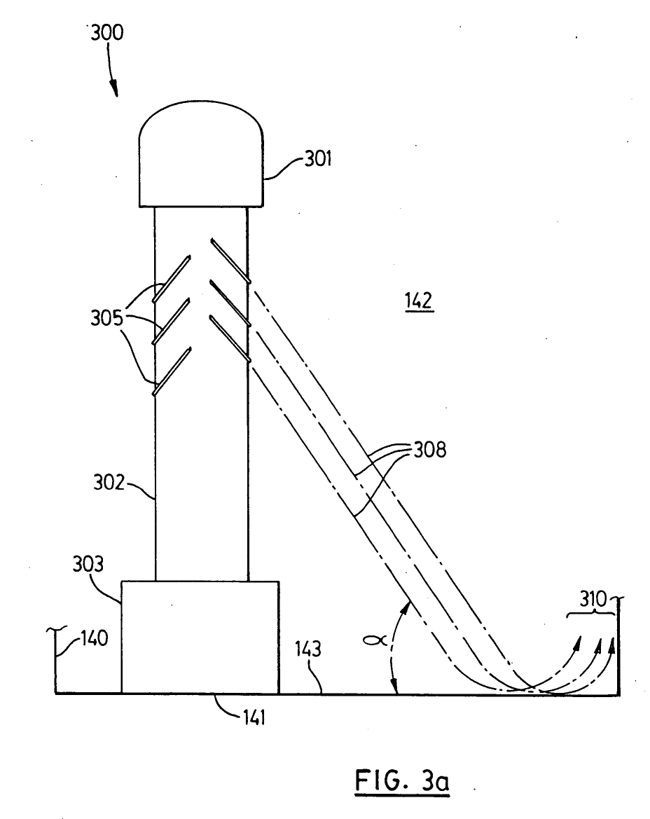

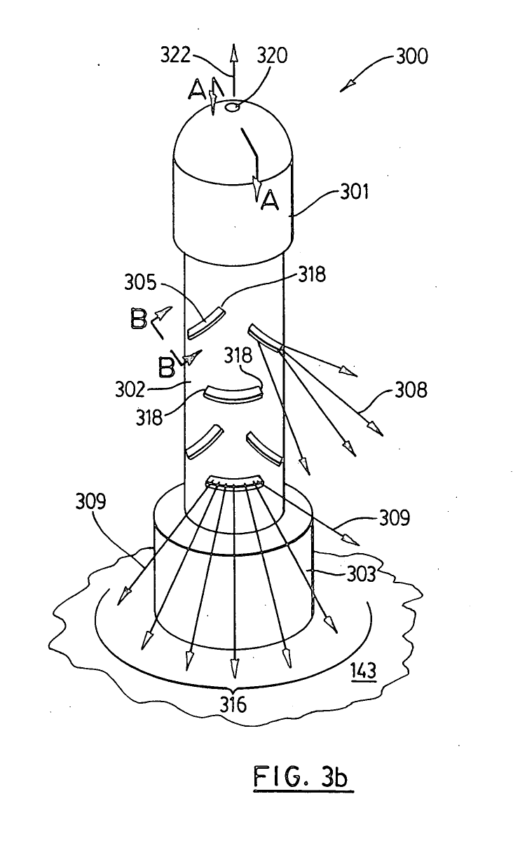

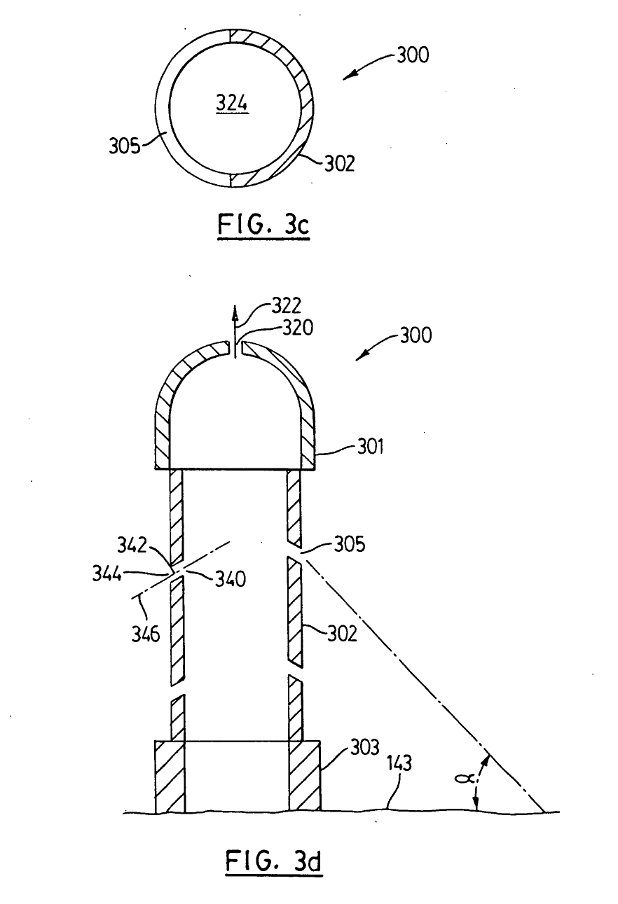

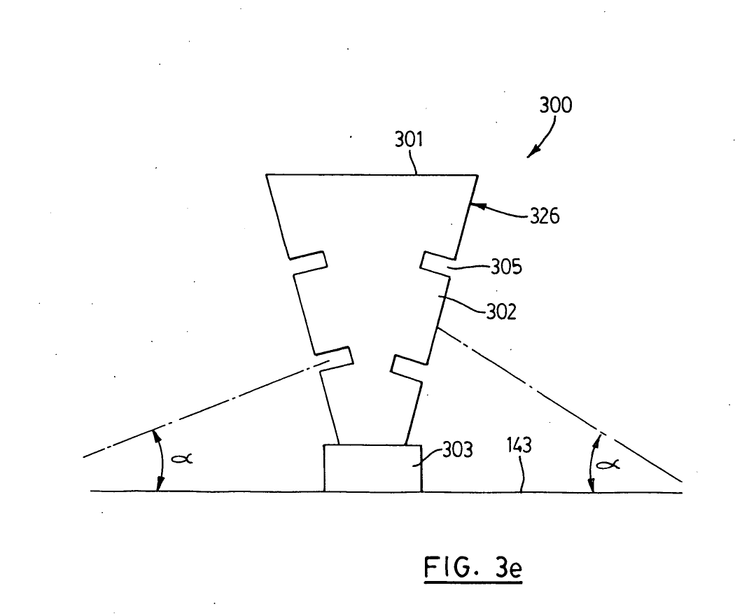

Referring to FIG. 3a, there is illustrated an embodiment of mixer or diffuser 300 mounted on the bottom 143 of any suitable contact tank 140 over its base inlet 141, for the purpose of enhancing mixing (and to extend the contact time available before ozone degrades back to oxygen) inside contact tank 140, of ozonated water stream 132 with water body 142 already in said tank. Mixer 300 produces secondary currents 310 within contact tank 140 by directionally expelling water as primary jets 308 downward to bottom 143 against which said jets 308 are deflected to induce secondary currents 310 in water body 142 the result of which is a beneficial swirling action inside tank 140.

According to one embodiment, mixer 300 is a substantially tubular body 302 made of PVC or any suitably priced ozone safe material. Body 302 is fluidly coupled to tank bottom 143 using connector 303 to receive stream 132 through inlet 141. A cap 301 is fastened by any suitable means to body 302 on its end opposing inlet 141 to prevent water escaping mixer 300 except through a plurality of narrow (for example, but not in limitation, 1.125 inch slot arc length [between the ends 318 (see FIG. 3b) of the slots 305]×0.013 inch slot gap [for a body 302 diameter of one inch) slots 305] cut at an acute angle α of approximately 40 degrees downward with respect to the bottom surface 143, which slots 305 produce a plurality of jets 308 of water exiting body 302 at positions that may be adjusted according to the diameter of tank 140 and the location of slots 305 above tank bottom 143. By so directing jets 308 two advantages are achieved. First the amount of sediment that collects on tank bottom 143 is reduced by constantly washing same and keeping sediment in suspension so that it will exit in discharge stream 165 for downstream removal by a supporting filter system (not shown). Second, the initial downward flow of jets 308 drives gas-entrained water against the natural direction of dissipation of gas which is upward to the top of tank 140 as the gas attempts to separate and escape into the gas pocket at the top of the tank 140, above the liquid level. Downwardly flow of the gas-entrained water extends contact time by creating a longer escape path that gas bubbles must follow. This extended bubble travel time means that less (if any) ozone will escape the liquid before it has a chance to react with contaminants by oxidation, advantageously reducing the amount of ozone present in gas vented off, to almost zero. Mixer 300 sizing and placement is adapted to the particular tank 140 to establish both the effective washing of bottom 143 and the establishment of a satisfactory secondary current 310, flowing initially downward, then up the inner sides of the tank 140 and thereafter back downward along a column roughly in the center of tank 140.

Cap 301 causes aggressive mixing inside body 302 as flow is both redirected and restricted. Stream 132 is delivered under enhanced pressure from pump 100 into body 302 through which it passes before striking the inner surface of cap 301 and reflected back into body 302 from which it exits via slots 305. Such re-circulation inside body 302 aggressively blends water with additive thereby facilitating contact between water borne additive and contaminants even before stream 132 escapes through slots 305 into tank 140 for the main contact activity. When used in conjunction with a re-circulation path as in systems 90 or 94, mixer 300 may be used to substantial advantage to restrict the amount of re-circulation to avoid wasting ozone by passing a greater percentage of water body 142 repeatedly through the re-circulation path than is strictly useful for disinfection purposes. For example, an embodiment of system 90 regulated for a treated water discharge of 15 gallons per minute could, in order to limit re-circulation to 50%, use a mixer 300 configured to restrict outflow through slots 305 to 22.5 GPM, such that, even though pump 100 may be capable of pumping 30 GPM, only 7.5 GPM would be available for diversion through re-circulation conduit 210, thereby limiting same to the desired portion. The interaction between available pump capacity and re-circulation may be used to enhance the exit pressure of jets 308, which pressure is a factor in the effective washing of bottom 143 as is achieved by matching the dimensions of a given tank to a given mixer 300 configuration. The total cross sectional area of the slot exits 344 (see FIG. 3d) in an exterior surface 326 (see FIG. 3e) of the body 302 is preferably less than the total cross sectional area of the tank inlet 141, such that the interior 324 (see FIG. 3c) of the body 302 becomes pressurized as the fluid contained in the stream 132 flows from the mixer 300 and into the tank 140. This increase or differential in pressure between the interior 324 of the mixer 300 and the tank 140 helps to increase the velocity of the fluid contained in the jets 308.

Referring to FIG. 3b, an alternative embodiment of the mixer 300 shows the directed jets 308 spread out in a fan shaped flow 316 towards the bottom surface 143 of the tank 140, with jets 309 representing the outer boundaries to either side of the fan flow 316. The slots 305 are cut in the sidewall of the body 302, such that the ends 318 of the slots 305 direct the respective boundary jets 309 towards the bottom surface 143 rather than the sides of the tank 140. The cap 301 has a bleed hole 320, preferably located in the centre of the top of the cap 301. The bleed hole 320 is sufficiently sized, for example such as but not limited to a diameter of 1/16 inches, to allow for any accumulated gases (represented by arrow 322) in the cap 310 to escape to the interior of the tank 140, rather than through the slots 305. Periodic discharges of accumulated gases 322 through the slots 305 is to be discouraged, as these discharges may disrupt any established secondary currents 310 in the tank 140. Further, the sizing of the bleed hole 320 is such that any substantive flow of the fluid stream 132 through the cap 301 is inhibited, rather the majority of the fluid stream 132 enters the mixer 300 and is redirected through the slots 305.

Referring to FIG. 3c, the hollow interior 324 of the mixer 300 is shown, with the slot 305 cut partway through the circumference of the body 302 at an angle with respect to the diameter of the body 302. Referring to FIG. 3d, the slots 305 are show cut in the body 302 at the angle alpha with respect to the bottom surface 143 of the tank 140. The slots 305 have an entrance 340, a passageway 342, and an exit 344 for directing the jets 308, such that the passageway 342 is situated along an axis 346 that can be oriented at the angle alpha with respect to the bottom surface 143.

Referring to FIG. 3e, alternatively the slots 305 can be cut into the body 302 at an approximate angle of 90 degrees with respect to the exterior surface 326, while the slots 305 still remain directed towards the bottom surface 143 of the tank 140, as the angle alpha is maintained between the body 302 sidewall and the bottom surface 143 in view of the orientation of the sidewall with respect to the connector 303. It is recognised that the angle alpha of the slots 305 with respect to the bottom surface 143 of the tank 140 can be accomplished in a number of different ways, such as but not limited to those shown in FIGS. 3a and 3e.

Contact tank 140 includes a primary reservoir 20 and a chamber 150. The primary reservoir 20 receives the treated aqueous fluid via inlet 140. The chamber 150 is fluidly coupled to and disposed above the reservoir 20 to receive and contain any gases leaving the fluid 142.

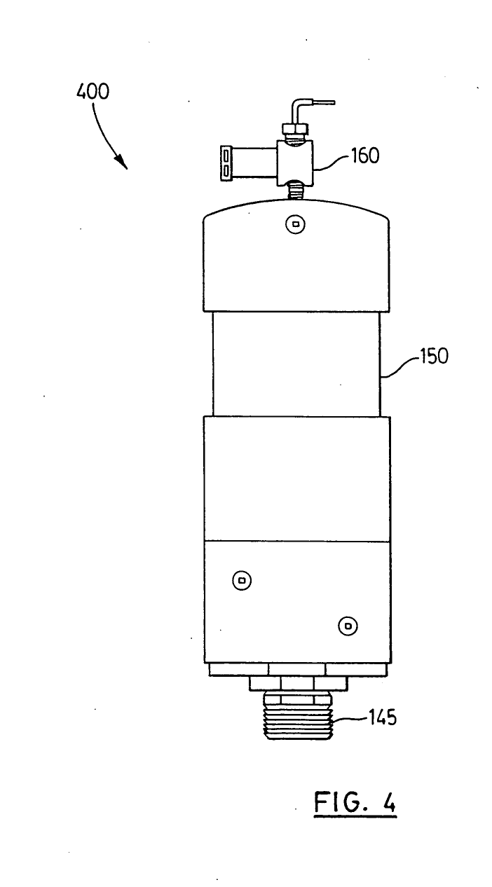

Referring to FIG. 4, a gas-off assembly 400 is shown having a chamber 150 for use in accumulating units of reaction by-products and residual additive gasses that escape from liquid phase in contact tank 140 through conduit 145 into chamber 150, where those units have the opportunity to separate from the liquid and join a pocket of gas inside chamber 150 from which they may be vented through any suitable controllable valve 160. When using ozone as additive 120, during the time period in which the fluid 142 circulates inside tank 140 (some of) the tiny bubbles of ozone rise (slowly) to the top of tank 140 together with air, oxygen formed by the re-combination of oxygen atoms released as ozone ions de-ionize during the oxidation of contaminants, and other gases. These gases exit contact tank 140 through outlet conduit 145 into gas-off chamber 150 where they accumulate, but which chamber is (in normal operation) always partially filled with liquid water forming the top of body 142. As demand for treated water 102 ceases source water 101 enters system 90 such that chamber 150 fills to a desired level (replacing the water discharged) until sufficient back pressure closes check valve 200.

Water having entrained gas is of a lower density, such that there is less liquid per unit volume than will be the case once the gas separates from the liquid. Further, as gas separates from liquid it will tend to rise and collect above the body of liquid such that gas pressure will build and push down on the liquid water at the same time as the body of liquid contracts to a higher density, both processes tending to cause the liquid level inside chamber 150 to fall.

The chamber 150 defines a first space 151, and the reservoir 20 defines a second space 22. The first space is disposed above the second space. The rate of increase of cross-sectional area of the first space 151 with respect to height, in a downwardly direction, is less than the rate of increase of cross-sectional area of the second space 22 with respect to height, in a downwardly direction. In this respect, it is preferable that the liquid-gas interface disposed between the liquid and gas phases in the contact tank 140 is disposed in the chamber 150. This is because the cross-sectional area of the liquid interface in the first space 151 is less sensitive to changes in liquid level than the surface area of a liquid interface disposed in the second space 22. Changes in liquid level (i.e. lowering the liquid level) in the second space 22 result in relatively larger increases in interfacial surface area, due to the configuration of the reservoir 20. In fact, a small decrease in a liquid level in the reservoir 20 from proximate the top 24 of the reservoir 20 results in an interface having a substantially larger surface area than a liquid interface at any level in chamber 150. This providing greater opportunities for ozone entrained/dissolved in the fluid 142 to escape the fluid 142. On the other hand, reducing the liquid level of an interface disposed in the first space 151 does not result in a significant increase in surface area of the interface. As a result, opportunities for ozone entrained/dissolve into fluid 142 to escape the fluid 142 do not change or do not substantially change as the liquid level moves downwardly in the first space 151. In this respect, the system is configured so that the liquid level of fluid 142 preferably remains disposed in the second space 22 of chamber 150 so as to limit escape of ozone from the fluid 142, and thereby increasing the opportunity for reaction between the ozone and the contaminants.

According to a preferred embodiment of the system of the present invention, a liquid level detection circuit (typically implemented by electrodes installed at different levels inside chamber 150) independent of the pump control circuit, controls the level of liquid water in chamber 150, such that when the water level drops to a predefined point, a valve 160 on chamber 150 opens to vent accumulated gas until the liquid water level returns to a different (higher) predefined point. In this respect, a controller is provided and communicates with the chamber 150 for receiving a low liquid level indication in the chamber 150. Upon receiving the low liquid level indication, the controller effects opening of valve 160 to discharge at least a portion of the gas accumulated in the chamber 160. This reduces pressure within the system 90, and permits the liquid level within the chamber 160 to rise. According to a preferred embodiment, even though there will be a relationship between the pressure inside system 90 and the level of liquid water in chamber 150, pump 100 is separately controlled and responds to pressure indications in system 90 (for example, positioned to sense line pressure in conduit 170). Pump 100 only operates if system 90 pressure drops below a predefined level, usually caused by demand resulting in outflow 102. Consequently, even if the valve venting chamber 150 opens, pump 100 will not begin to operate to run until the impact of venting is such that the pressure of system 90 drops below said predefined level.

The chamber 150 always has water in it because the “minimum level” electrode switches on pump 100 as soon as the electrode loses contact to ground, using any suitable controller to cause pump 100 to stay on until the “maximum level” electrode makes contact shorting it to ground. Consequently, tank 140 is always full of water (i.e. no separated gas), which reduces the opportunity for the small gas bubbles to leave solution as they would do more readily if they made contact with a pocket of gas across the top of tank 140. Conduit 145 having a relatively small cross-sectional area through which bubbles must pass to reach the gas separated from solution in the gas-off chamber presents a minimal opportunity for tiny bubbles of dissolved ozone (i.e. additive 120) to contact a pocket of gas and leave solution before being either reflected down into tank 140 or caught up in secondary current 310 and drawn down into tank 140 where they have a further opportunity to contact and oxidize contaminants.

According to one embodiment of the system of the present invention, the pressure-controlled valve 160 is positioned on top of chamber 150 and configured to vent gases to a safe location. It is contemplated that venting could be to a gas separation and recovery or destruction device if environmental regulations require such handling at some point in the future.

The treated aqueous fluid stream is discharged from the contact tank 140 in response to a demand from a user, typically arising from the opening of a downstream valve 30. The concentration of the at least one contaminant in the aqueous fluid stream being discharged would have been reduced to an acceptable level by reaction with the fluid reagent. A portion 102 of the discharge stream from the contract tank is delivered as product water to the end user. A portion 210 of the product water is bled from the discharge stream and combined with the untreated water stream to produce the combined treatment fluid stream 112. In this respect, a portion 210 of the treated aqueous fluid stream is said to be recirculated through the system. A non-return valve or check valve 205 is provided to prevent back flow of the untreated aqueous fluid stream and/or treatment fluid stream 112. Without the check valve 205, such steams would bypass the fluid reagent injection assembly 12 and, possibly, effect discharge of untreated water as product water 102. A non-return valve or check valve 200 is also provided to prevent backflow of the untreated aqueous fluid stream 101 and/or treatment fluid stream 112 towards the untreated water source.

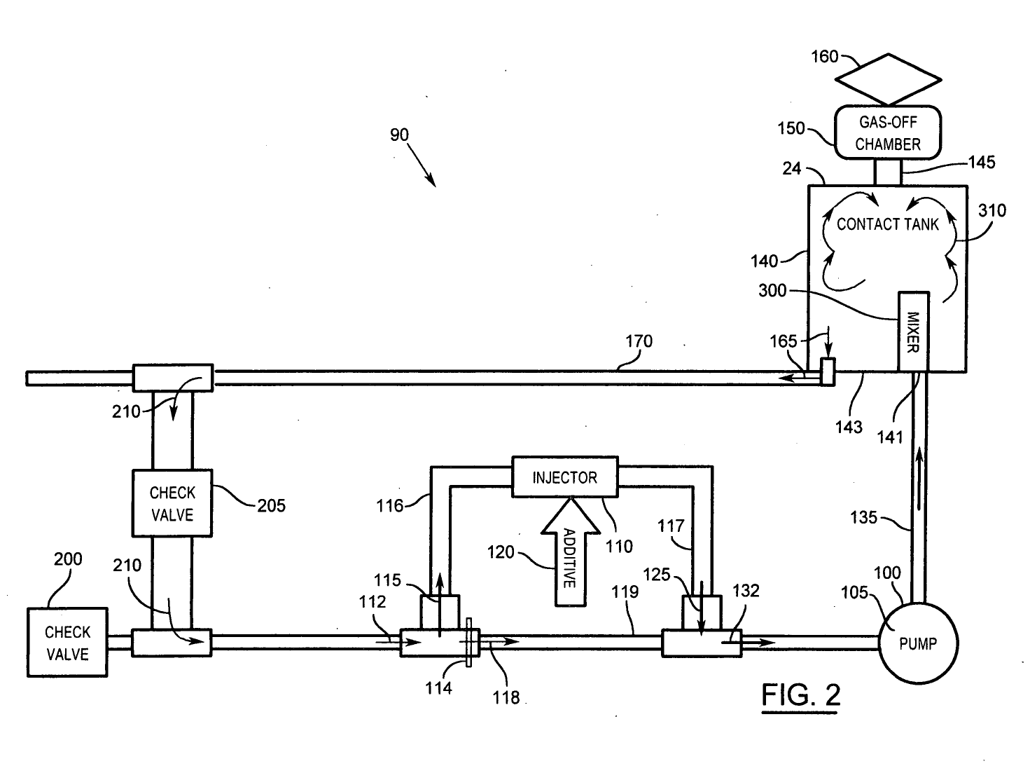

By opening valve 30, fluid 142 is discharged from tank 140 via discharge stream 165 through the bottom of tank 140. Stream 165 encounters a re-circulation path (see FIG. 2) comprising conduit 201 and check valve 205 (typically a one-way swing check valve), which path permits stream 165 to split into streams 102 and 210. Stream 102 departs system 90, after which it may be advantageously filtered to remove oxidized sediment, rust and other particulates more efficiently as a result of larger particle size resulting from contact with ozone ions. Stream 210 passes through valve 205 to combine with any source water stream 101 entering until sufficient back pressure forces check valve 200 to close, preventing flow form source water stream 101. Streams 101 and 210 then combine to form stream 112, which moves through and past the injection assembly as set out earlier herein. Since the stream 210 portion of stream 112 has already been treated at least once, the partially treated stream is treated again resulting in further purification. Eventually, the pressure in the re-circulation loop rises slightly above line pressure such that check valve 200 operates to prevent backflow to the source. Once demand ceases and pressure in the treatment loop rises above line, no further source water 101 will enter through valve 200 and the fluid 142 will cycle/re-circulate until the pump is switched off by a controller in response to a high pressure indication in the system.

Referring to FIG. 2, there is illustrated system 90 shown in re-circulation mode with no inflow or discharge. In this state, contact tank 140 is full, chamber 150 has reached its maximum level, and pump 100 continues to operate keeping pressure in the re-circulation loop above source line pressure such that check valve 200 operates to prevent backflow to the source. Pump 100 will continue to operate for a definable period of time controlled by any suitable controller circuitry (not shown), which time is typically defined by the volume of tank 140 and the level of treatment (for e.g. sterilization, turbidity, colour, odor, taste) required at the load. For example, a larger tank supplying a more sterile application such as hotel food service would typically re-circulate for a longer period of time than would a smaller tank used to supply drinking water to a feedlot for cattle. As the previously treated stream 112 is drawn through the injection assembly by the suction of pump 100, it splits into streams 115 and 118. Stream 115 is further enriched with (ozone) additive 120 to become enriched stream 125 and recombine with previously treated stream 118 to become stream 132 and be returned to tank 140 bearing a fresh supply of (ozone) additive 120 that is diffused into body 142 where it may contact contaminants not yet destroyed by contact with previously resident additive 120. After a predefined period of time (without discharge) the controller cuts power to pump 100 and system 90 remains static (flow) until new demand results in sufficient discharge (described by FIG. 1) that the associated change in pressure (in chamber 150 or elsewhere) to permit source supply water to flow in through check valve 200 and/or to trigger the controller to restart pump 100. During the period in which the flow of system 90 is static, the units of additive 120 move freely throughout the water in the conduit and tank 140 contacting and oxidizing contaminants as they are encountered. Having a sufficiently large contact tank 140 (and gas-off chamber 150) can result in a very long average contact time permitting additive action to continue for hours or even days at a time, until all of the very slow moving tiny bubbles entrained in body 142 rise through conduit 145 via which they can escape to chamber 150.

Re-circulation is made possible by the above arrangement of check valves 200 and 205 in system 90. A first check valve 200 is placed immediately downstream of an inlet pressure regulator to prevent flow towards the source. A second check valve 205 is placed between and downstream of the outlet of the contact tank (e.g. in conduit 170) and the inlet of the ozone injection assembly (e.g. in conduit 116), but positioned immediately upstream thereof. This arrangement of check valves enables system 90 to cycle slightly above line pressure without either back flow to the source or bypassing the ozone injection assembly. After the demand for treated water ceases to permit discharge, pump 100 may continue to run, drawing in source water stream 101 until the pressure in the treatment loop exceeds the line pressure of the source. The water level in contact tank 140 is maintained at a desired level by a gas-off valve 160 and suitable circuitry. Water in contact tank 140 may be re-circulated by the pump sucking it through second check valve 205 between said outlet of the contact tank and positioned immediately upstream of the ozone injection assembly. Re-circulating treated water becomes feed water for the injection assembly such that fresh ozone (or other additive) is entrained in the re-circulating stream of previously treated water. Advantageously, when using ozone as the additive 120 there is no risk of “over treatment” per se such that re-circulation virtually ensures the destruction of any micro-organic contaminants that were not contacted during either the first additive injection or the first period of residence in the contact tank. Since the number of re-circulations that will be beneficial is, in a practical sense, limited, the controller circuitry may be programmed to cease re-circulation after a definable period of time, restarting when tank pressure drops as a result of treated water being discharged to the load.

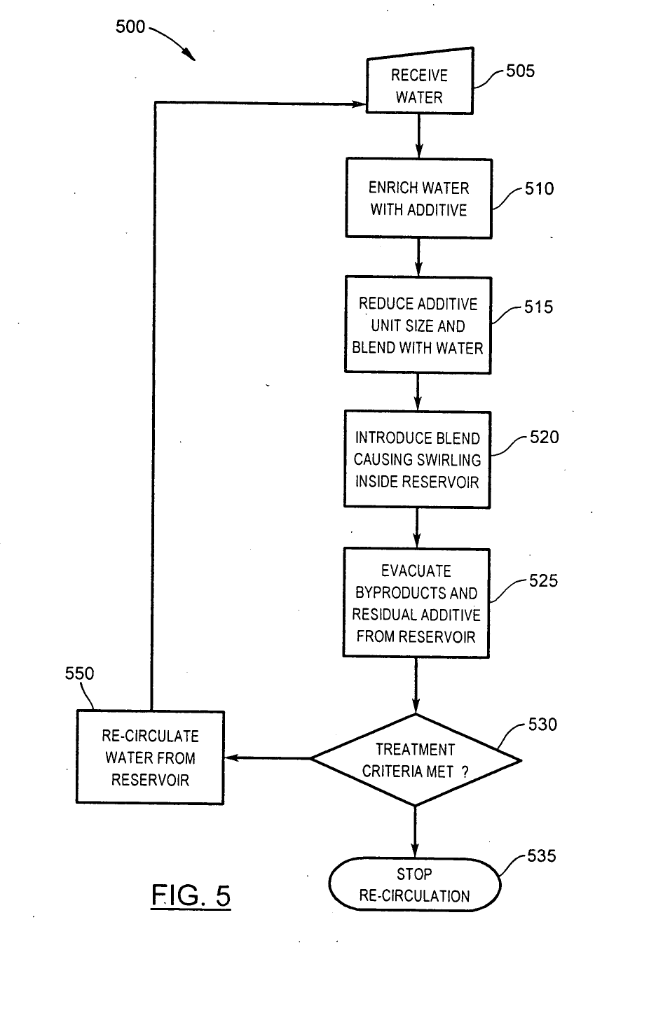

Referring to FIG. 5, there is illustrated a method of using the system 90 shown in FIG. 1. Each of: step 515 enhancing blending, step 520 the directed swirling introduction of an enriched water stream into a body of water under treatment, step 525 the delayed separation of un-reacted additive (via the suppression of spontaneous separation) from water, and step 550 the controlled re-circulation of water under treatment provide significant advantages over conventional methods of water treatment based on injecting an additive and extending contact time by using a contact tank. At step 505, water is received typically from a pressure regulated source in the form of input stream 101. By any suitable means, typically direct injection, an additive 120 such as ozone is introduced into at least a portion of stream 112 at step 510. A person of skill in the art would understand that different additives may be most effectively introduced by different means, but where the additive 120 is a gas such as ozone a venturi-type injector works well. Although system 90 as illustrated in FIGS. 1 and 2 includes a bypass form of injection assembly, a person of skill in the art would also understand that if an injector 110 of sufficient capacity is available, then it may be inserted directly inline with stream 112 eliminating the need for flow constrictor 114 at the same time as conduits 116 and 117. After stream 112 has been suitably enriched with an additive 120, step 515 further breaks down the units of additive 120 in the process of enhancing the blending, by any suitable means, of said units with the water in which it is already partially entrained. This further reduction in unit size and enhancement of blending results in additive 120 becoming substantially homogenized with the water, advantageously increasing the uniformity of density of the fluid blend exiting blender 100 (typically a pump). The further step 520 of introducing the blended fluid into a reservoir, such as contact tank 140, in a manner that causes the fluid jets 308 to wash tank base 143 and then swirl (substantially vertically) inside the reservoir following a route and pattern that substantially lengthens the bubble travel path, advantageously facilitates contact between units of additive 120 and contaminants—as compared to the conventional (side stream) introduction of fluid permitting units (typically bubbles) of additive to simply rise through the water in the tank to contact contaminants. The further step 525 of evacuating by-products and residual additive from the reservoir in a manner that permits the reservoir to remain full of blended fluid, advantageously prevents units of additive spontaneously leaving solution as early as they would if contact with a large pocket of additive were permitted. To execute step 525 in the required manner chamber 150 is used to collect separating by-products and additive through the restricted access of conduit 145 such that the actual separation of un-reacted additive is delayed by the suppression of the opportunity for spontaneous separation, which suppression is a consequence of the restricted access to the controlled pocket of separated by-products and additive that is permitted to accumulate in chamber 150 rather than in communication with a larger surface area of fluid at the top of the contact tank 140. A person of skill in the art would understand that Step 550, the re-circulation of water under treatment, may be implemented only in response to an assessment of the need for further treatment, or continuously such that it is stopped upon the determination that there is no need for further treatment. The provision of any suitable re-circulation path is necessary to permit the re-treatment of any volume of the water leaving the reservoir after at least one treatment, and the use of a pump as blender 100 is necessary to permit re-circulation during periods when the inlet and outlet to system 90 or 94 are closed such that there is neither any inflow nor any outflow to cause water to move through injector 110 where more additive may be acquired to further treat water in the reservoir. A person of skill in the art would understand that how much re-circulation is appropriate (both useful and tolerable) will depend on the additive in use as well as the volume of water being re-circulated, in addition to other well understood factors. Further, any suitable testing and control devices may be used to determine whether or not treatment has been adequate and to terminate re-circulation based on such determination. According to an economical embodiment of system 90 or 94, a simple pressure change sensor or timing device may be used to limit the operation of pump 100 thereby, based on the specifications of the system at the time it is designed, terminating re-circulation after a suitable amount of re-circulation has been completed.

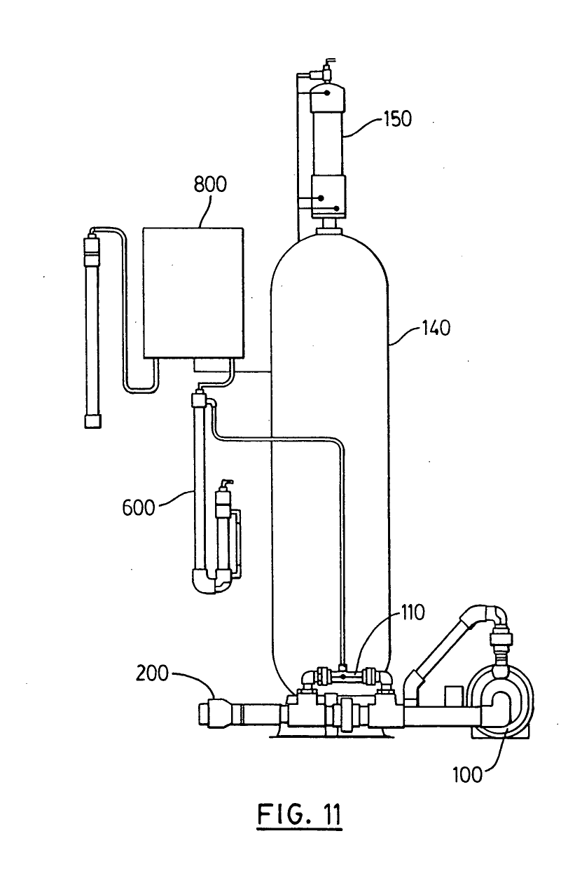

Referring to FIG. 6 and according to another embodiment of the invention, a water column device 600 may be fitted to the system 90 between the injector 110 and an ozone generator 800 (shown in FIG. 11) to safeguard the ozone generator from flooding due to an injector check valve failure. Advantageously, system 90 may be protected by such means to supply ozone to the injector while protecting the ozone generator from water damage. Although most venturi-type injectors have a check valve built-in, such check valves can fail while the treatment system is pressurized, causing the generator to fill with water and short-circuit the next time it powers on, both damaging the generator and creating an electrical safety concern. To eliminate this risk a water column device 600 is plumbed in between the ozone generator and injector 110. During normal operation, ozone gas from the generator is drawn to the water column device through inlet 601 by the vacuum created by the venturi action of injector 110, which vacuum also evacuates ozone through outlet 602 pulling it into the water stream via injector 110. In the event of an injector check valve failure, water backs up from the injector into water column 600 through outlet 602 raising the water level in the column above its normal level 604, and eventually above outlet 603 that may be plumbed to any suitable drain. Flood water exits outlet 603 such that it never rises to the level of inlet 601, eliminating the risk of flooding the ozone generator with water backing up through injector 110. This apparatus also prevents flooding of the area where the system is installed. And, very little ozone is lost as a result of its passage over the top of the water column.

According to a preferred embodiment of system 90, the control circuitry of the ozone generator is adapted to shut down the delivery system, if the generator fails for any reason. An electronically controllable shutoff valve is plumbed in advance of the system, so that when the ozone generator is not running, the source water supply is shut off at the same time the discharge system is shut down, ensuring that if the ozone generator is not functioning, then no untreated water may be drawn from the system.

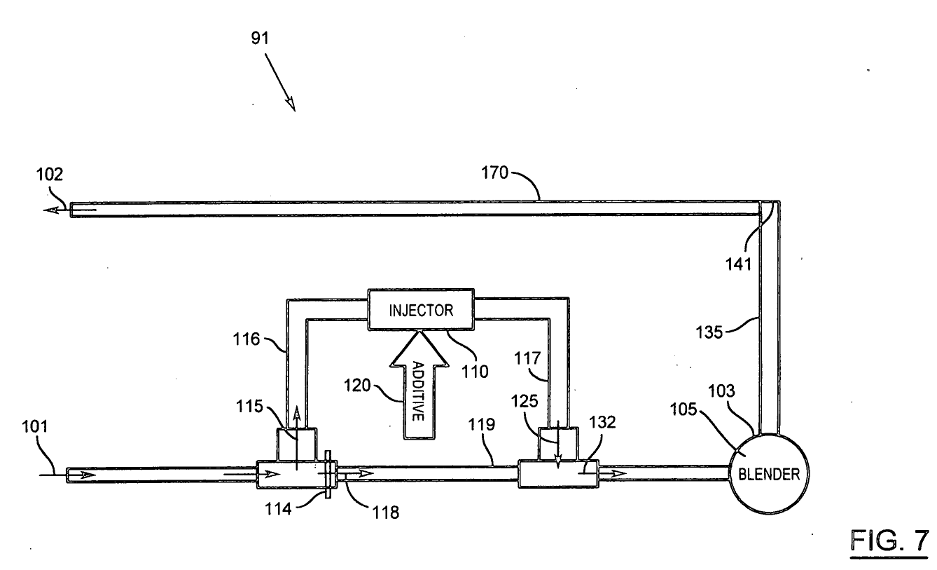

Referring to FIG. 7, there is illustrated an injection assembly denoted generally as 91 (being a portion of system 90), shown with any suitable blender 103 (typically a pump) to shear units (typically bubbles) of additive 120 for the purpose of better blending with the water being treated. Apparatus 91 may be adapted to operate under only the line pressure of stream 101 or with a pressure boost from blender 103. It is contemplated that apparatus 91 may be retro-fit into existing ozone based treatment systems to improve their operation by further blending additive with the water stream to reduce bubble size and increase contact surface area while enhancing distribution, thereby facilitating contact between water borne additive (typically a disinfectant) and contaminants. Although if conduit 170 is of sufficient length substantial contact may occur therein, installing apparatus 91 inline with a conventional contact tank would significantly improve both contact quality (blending) and opportunity (time).

Since water supplies and venturi-type injectors exist in many different capacities, it is contemplated that, according to one embodiment of the system of the present invention, not all of the source water shall flow through the injector prior to reaching the contact tank. A portion of each of the source and re-circulation water bypass the injector flowing instead through a flow constriction device placed in the bypass conduit of the ozone injection assembly to ensure that sufficient water will flow through the (higher resistance) injector to draw in ozone. The flow constricting device may be a simple disc (housed in the union adjacent the injector) perforated to permit design flow, while ensuring adequate flow through the injector.

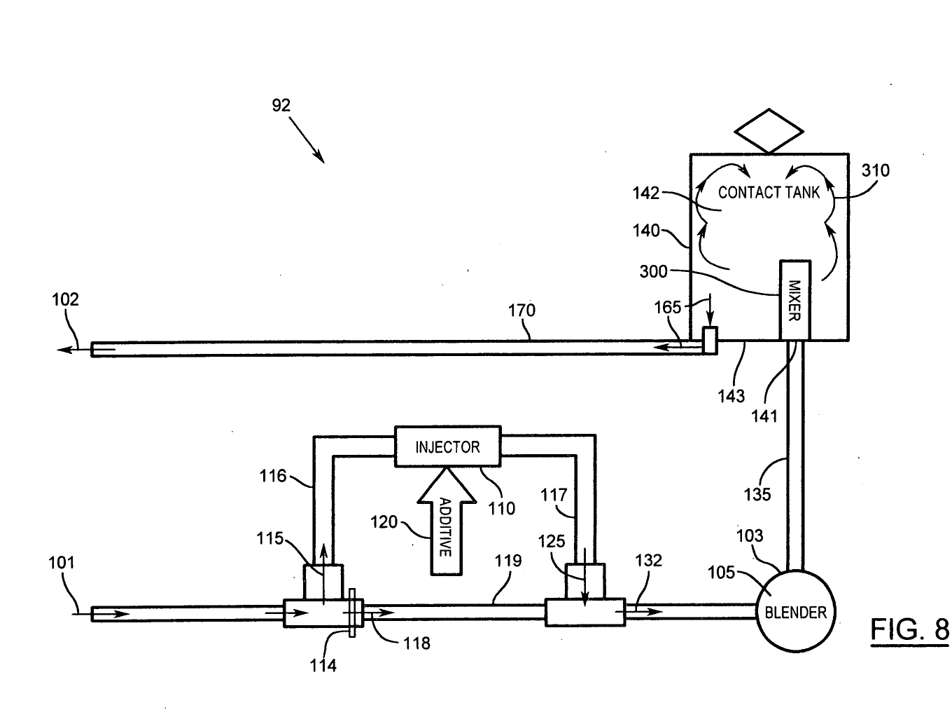

Referring to FIG. 8, there is illustrated a portion of system 90 denoted generally as 92, a diffusion apparatus (being mixer 300) in which together with a contact tank 140 have been added to the injection assembly 91 (including blender 103) of FIG. 7 have been added. Convention current 310 created by mixer 300 serves to further improve both contact quality (blending) and opportunity (time) over that of system 91 adding a blender downstream of said injection assembly.

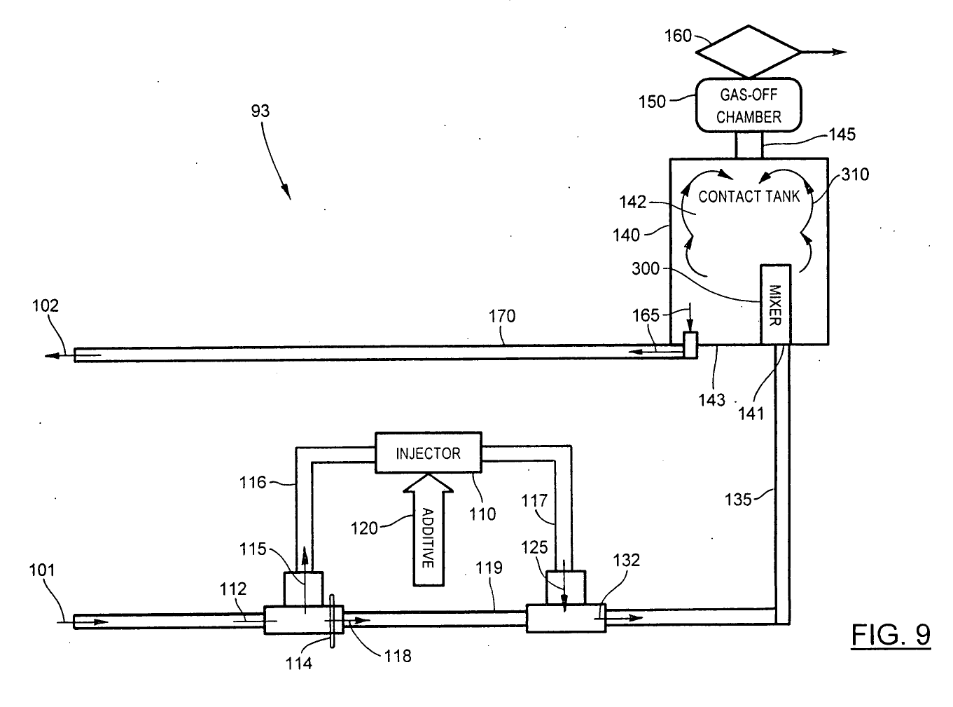

Referring to FIG. 9, there is illustrated another embodiment system 93, in which the injection assembly of FIG. 7, but without enhanced blending of a separate blending element, sends an ozone enriched stream of water directly to diffusion apparatus 300 installed inside an improved contact tank assembly that includes an apparatus being gas-off chamber 150 for slowing the separation of ozone from water. Chamber 150 releases accumulated gas through venting valve 160 in a manner that ensures chamber 150 is never dry during normal operation. Chamber 150 is accessed by conduit 145 only—such that all gas bubbles rising inside contact tank 140 either escape to chamber 150 or circulate with secondary current 310. Gas bubbles cannot come in contact with a pocket of gas and leave solution except by escaping to chamber 150 via conduit 145. As a result both contact quality (blending) and opportunity (time) are further enhanced by the use of chamber 150 together with a contact tank having mixer 300. However, the existence of a gas pocket does not per se promote separation. If a lower density fluid is entrained in a liquid it will naturally rise within the body of liquid, but if there is no opportunity to escape the liquid phase, then it is forced to remain in solution. By reducing the escape route from an area covering the entire surface of the liquid inside contact tank 140 to an area the size of conduit 145 separation is suppressed by the reduction of access to an escape route.

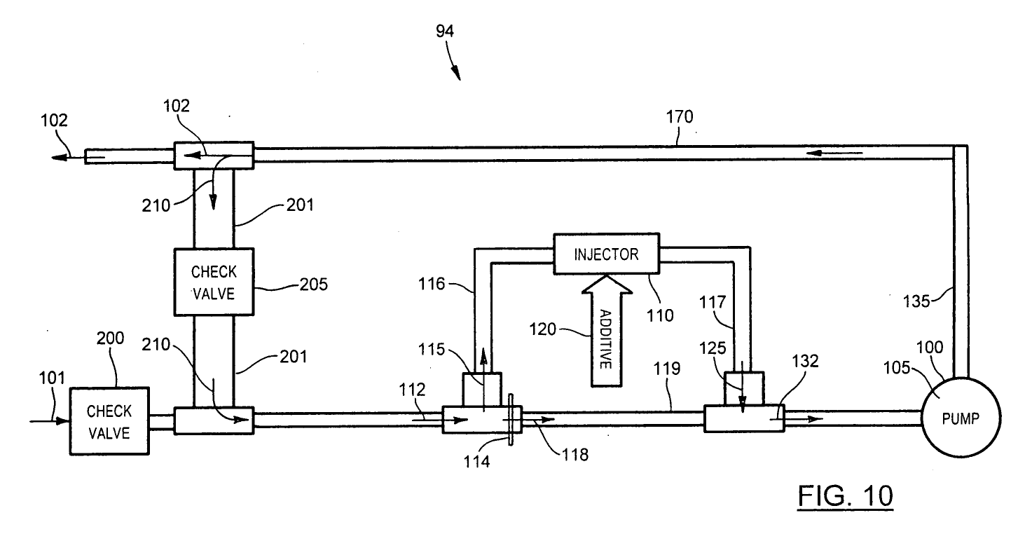

Referring to FIG. 10, there is illustrated another embodiment of the re-circulation system of the present invention, denoted generally as 94, in which the injection assembly of. FIG. 7 has been further enhanced by the addition of a re-circulation path assembly comprising return conduit 201 and return check valve 205 facilitated by check valve 200 preventing backflow to the source. Although it is contemplated that a passive version of re-circulation system 94 will achieve increased opportunity for contact between additive and contaminants, according to a preferred embodiment pump 100 will be used, instead of either line pressure or blender 103, to ensure aggressive blending and significant re-circulation resulting from the pumping energy input to system 94 by pump 100. It is contemplated that re-circulation system 94 may be retro-fit into conventional water treatment systems with or without a contact tank.

It will be understood by a person of skill in the art that contact tank capacity is selected to ensure a contact time of at least 4 minutes, which period of residence is affected by both the capacity of the tank and the net outflow from the treatment system. The contact tank and re-circulation process together eliminate the need for large doses of ozone and the generators needed to produce them. Since both the primary and residual gasses produced during ozonation treatment need to be removed from the treated water prior to discharge to the load, it is advantageous to entrain less ozone in the water and to use that gas more efficiently while in solution. By using a contact tank with a long period of residence it is normal to have significant “gassing off” inside that tank, such that the contact tank requires a way to release gas as it separates from the treated liquid. In one embodiment, this is done using a liquid level driven gas off valve and digital pressure switch controlled by circuitry (controlling electrical power to both the circulation pump and the ozone generator), which maintains contact tank water level. The circulation pump cycles on and off as pressure decreases with demand and increases with additional source water restoring the contact tank level. The treatment system can be programmed to cycle re-circulating water from the contact tank through the additive injector for any amount of time after demand has ceased. Typically a pressure sensor is located immediately downstream of the contact tank. To ensure adequate treatment of all water discharged from the system a flow rate control is plumbed inline with the outlet valve to limit discharge to the design capacity of the treatment system. And, the circulation pump is selected to exceed said system capacity such that even while water is being discharged from the system, the flow within the re-circulation path remains positive with a portion of the water exiting the contact tank being forced through the ozone injection assembly rather than being discharged enhancing contact time and treatment effectiveness. For example only, according to one embodiment a 12 GPM pump is used in a 7.5 GPM capacity system to recycle 4.5 GPM even when the system is discharging at its full capacity. According to a preferred embodiment the above referenced control circuitry also contemplates a failure in either ozone generation or source water supply interrupting power to the system to ensure that all water discharged from the system has been adequately treated.

A person of skill in the art would understand that the volume of the contact tank required for effective treatment increases as the design capacity of the system increases. For example, a 5 gallon per minute (GPM) system typically deploys a 20 gallon contact tank and a larger 30 GPM system typically deploys a 120 gallon contact tank. Similarly, the venturi-type injector is selected according to the design capacity of the water system. For smaller water systems a venturi-type injector of sufficient capacity may be available such that all of the source water flows through the injector and is mixed with ozone prior to reaching the contact tank. As water system capacity increases, the required flow rate may exceed the capacity of the available injectors such that it becomes necessary to install a parallel bypass path to permit a portion of the source water to flow to the contact tank without first passing through the venturi-type injector. When such a bypass path is installed in parallel with the injector, it is designed to cause the proper amount of water to pass through the injector while allowing the balance of the required flow bypass the injector. According to a preferred embodiment, placing a suitably rated flow constriction device in the bypass path will generate sufficient backpressure to force a portion of the source flow to travel through the injector where it will pickup additive ozone. As the ratio of bypass to direct water flow increases it will be desirable to increase contact time by increasing either or both the contact tank size and the re-circulation time.

A person of skill in the art would understand that any suitable flow control device may be used in place of flow constrictor 114. And that water is withdrawn from tank 140 through the base 143 thereof via any suitable outlet adapted or positioned below the lowest extremity of mixer 300, in a manner or location that does not interfere with the maintenance of currents 310.

Continuous mechanical evacuation valves and similar devices tend to be unreliable and inaccurate, such that the system of the present invention contemplates the use of a large evacuation chamber 150 as advantageous for separating reaction by-products and residual additive, since it permits the expulsion of larger amounts of gas during each vent cycle, which helps prevent plugging of the solenoid valve and extends the service life of the valve. Further, given that small quantities of un-reacted ozone may be expelled in the vent gas, according to a preferred embodiment, venting is to a location (possibly through an ozone destructor) that ensures there is no risk of ozone build-up around system 90 or inside the building where it is located. A person of skill in the art would understand that the residual ozone in chamber 150 may become contaminated such that it should not be reused without reconditioning.

A person of skill in the art would further understand that when using ozone for additive 120 in system 90 pump 100 would typically be selected from any suitable class of pump capable of providing shearing and blending as well as propulsion, but would be a model manufactured from stainless steel and having seals or gaskets made of Teflon or Kynar because these materials are all “ozone safe” and stand up well to the high oxidation levels encountered. However as it is contemplated that the material sciences will continue to improve pump housings and seals, any pump made of material that is ozone safe may be used. Since heat from pump 100 creates the risk of accelerated degradation of the ozone gas, the selection of pumps that generate and transfer less heat is desirable. However since system 90 re-circulates a large quantity of water through contact tank 140, in practical terms, the pump heat transfer issue is not a problem. Further, since the controller of system 90 does not permit re-circulation pump 100 to operate continuously, pump heat buildup is negligible.

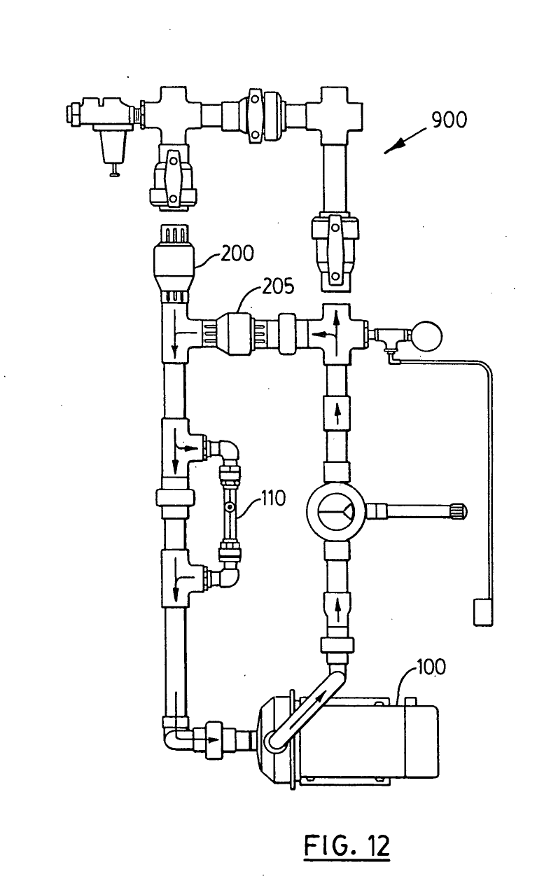

Referring to FIG. 11, there is illustrated in side view an embodiment of the system of the present invention shown connected to an on-site ozone generation device 800 protected by the flooding protection apparatus 600. Referring to FIG. 12, there is illustrated in top view an embodiment of the system of the present invention shown connected to an inlet and outlet flow control assembly 900.

Although the disclosure describes and illustrates various embodiments of the invention, it is to be understood that the invention is not limited to these particular embodiments. Many variations and modifications will now occur to those skilled in the art of water treatment. For full definition of the scope of the invention, reference is to be made to the appended claims.

1. A method of treating an aqueous fluid with a fluid reagent comprising:
providing an untreated aqueous fluid stream having at least one contaminant;
combining the untreated aqueous fluid stream with a portion of a treated aqueous fluid stream to produce a treatment fluid stream having at least one contaminant; and
effecting a reduction in the fluid pressure of the treatment fluid stream sufficient to effect a fluid pressure differential between the treatment fluid stream and a source of a fluid reagent to thereby induce introduction of the fluid reagent from the source of the fluid reagent to the treatment fluid stream, such introduction of the fluid reagent to the treatment fluid stream effects reaction of at least a portion of the at least one contaminant in the treatment fluid stream with at least a portion of the fluid reagent to produce the treated aqueous fluid stream.

2. The method as claimed in claim 1, wherein the reagent includes ozone.

3. A system for treating an aqueous fluid with a fluid reagent comprising:
means for introducing an untreated aqueous fluid stream having at least one contaminant;
means for combining the untreated aqueous fluid stream with a portion of a treated aqueous fluid stream to produce a treatment fluid stream having at least one contaminant; and
means for effecting a reduction in the fluid pressure of the treatment fluid stream sufficient to effect a fluid pressure differential between the treatment fluid stream and a source of a fluid reagent to thereby induce introduction of the fluid reagent from the source of the fluid reagent to the treatment fluid stream, such introduction of the fluid reagent to the treatment fluid stream effects reaction of at least a portion of the at least one contaminant in the treatment fluid stream with at least a portion of the fluid reagent to produce the treated aqueous fluid stream.

4. The system as claimed in claim 2, wherein the means for effecting a reduction in the fluid pressure is a venturi-type injector.

5. A method of controlling a surface area of an interface between a liquid and a gas, the gas and the liquid being contained in a vessel, the liquid having at least one contaminant and at least one gaseous reagent for reacting with the at least one contaminant to form a reaction product, the gas being disposed above the liquid to define an amount of gas on a mass basis, the interface permitting the at least one gaseous reagent or reaction product to migrate from the liquid to the gas, comprising:
measuring a high interface surface area indication; and
controlling the amount of gas in response to the high interface surface area indication.

6. The method as claimed in claim 5, wherein the amount of gas is controlled by discharging at least a portion of the gas from the vessel.

7. The method as claimed in claim 6, wherein the high surface area indication is provided when the interface is disposed at a level in the vessel below which the surface area of the interface would increase by an undesirable amount.

8. A system configured for containing a liquid and a gas, the liquid having at least one contaminant and at least one gaseous reagent for reacting with the at least one contaminant to form a reaction product, the gas being disposed over the liquid such that an interface is defined between the liquid and the gas, the interface permitting the at least one gaseous reagent or reaction product to migrate from the liquid to the gas, the system comprising:
a vessel including:
a first portion defining a first space; and
a second portion defining a second space, the second portion merging with the first portion, the second space being disposed below the first space, wherein the rate of increase of cross-sectional area of the first space with respect to height is less than the rate of increase of cross-sectional area of the second space with respect to height; and
a controller, communicating with the first space for receiving a low interface level indication in the first space, and configured to effect a discharge of at least a portion of the gas from the first space in response to the low interface level indication to prevent the interface from moving from the first space to the second space.

9. The system as claimed in claim 8, wherein the rate of increase of cross-sectional area of the first space with respect to height in a downwardly direction is less than the rate of increase of cross-sectional area of the second space with respect to height in a downwardly direction.

10. The system as claimed in claim 9, wherein the first portion of the vessel is defined by an elongated chamber.

11. A system configured for containing a liquid and a gas, the liquid having at least one contaminant and at least one gaseous reagent for reacting with the at least one contaminant to form a reaction product, the gas being disposed over the liquid such that an interface is defined between the liquid and the gas, the interface permitting the at least one gaseous reagent or reaction product to migrate from the liquid to the gas, the system comprising:
a vessel comprising:
a first portion defining a first space; and
a second portion defining a second space, the second portion merging with the first portion, the second space being disposed below the first space, such that the rate of increase of cross-sectional area of the interface with respect to height when the interface is disposed in the first space is less than the rate of increase of cross-sectional area of the interface with respect to height when the interface is disposed in the second space; and,
a controller, communicating with the first space for receiving a low interface level indication in the first space, and configured to effect a discharge of at least a portion of the gas from the first space in response to the low interface level indication to prevent the interface from moving from the first space to the second space.

12. The system as claimed in claim 11, wherein the rate of increase of cross-sectional area of the interface with respect to height in a downwardly direction when the interface is disposed in the first space is less than the rate of increase of cross-sectional area of the interface with respect to height in a downwardly direction when the interface is disposed in the second space.

13. The system as claimed in claim 12, wherein the first portion of the vessel is defined by an elongated chamber.

14. A diffuser for redirecting an introduced fluid stream from a vessel inlet towards a bottom surface of the vessel, the diffuser comprising:
a hollow body having a sidewall for defining an interior configured to receive the fluid stream, the sidewall having an interior surface and an exterior surface;
a connector fixed to the sidewall for coupling the body to the vessel inlet, the connector for providing fluid communication of the fluid stream from the vessel inlet and into the interior of the body;
an end wall connected to the sidewall and located oppositely to the position of the connector, the end wall for restricting fluid communication of the fluid stream from the interior and into the reservoir; and
at least one slot extending through the sidewall, the slot having an entrance located on the interior surface, an exit located on the exterior surface, and a passageway for effecting fluid communication between the entrance and the exit, the passageway being situated along an axis configured at an acute angle with respect to the bottom surface of the vessel;
wherein the passageway directs the fluid stream from the interior of the body and towards the bottom surface of the vessel.

15. The diffuser according to claim 14 further comprising a plurality of the slots extending through the sidewall, each of the slots defining an arc extending around a portion of a periphery of the sidewall of the body.

16. The diffuser according to claim 15, wherein each of the slots redirects a portion of the fluid stream as a redirected fluid jet towards the bottom surface of the vessel, each of the redirected fluid jets providing a fan shaped flow geometry of the respective fluid portion.

17. The diffuser according to claim 16 further comprising a total cross sectional area of the exits of the slots is less than the cross sectional area of the vessel inlet, wherein the difference in the cross sectional areas provides for a fluid pressure differential between the fluid contained in the interior of the body and the fluid contained in the vessel.

18. The diffuser according to claim 16 further comprising a hole located in the end wall for allowing accumulated gases in the interior of the body to escape into the vessel while promoting the redirection of the fluid stream through the slot.

19. The diffuser according to claim 15, wherein the vessel inlet is located on the bottom surface of the tank.

20. The diffuser according to claim 19, wherein the body is configured for orientation with the bottom surface such that the exterior surface of the sidewall is substantially perpendicular with respect to the bottom surface of the vessel.

21. A diffuser configured for mounting to a vessel having an interior bottom surface, the diffuser comprising:
a conduit defining a fluid passage for receiving a gas-containing liquid introduced through a vessel inlet; and
at least one slot defining a fluid passageway for effecting fluid communication between the fluid passage and fluid within the vessel, the passageway having an axis disposed at an acute angle relative to the interior bottom surface of the vessel.

22. The diffuser according to claim 21 wherein each of the at least one slot defines an arc extending around a portion of a periphery of the conduit.

23. The diffuser according to claim 22, wherein-each of the at least one slot redirects a portion of the fluid stream as a redirected fluid jet towards the bottom surface of the vessel, each of the redirected fluid jets providing a fan shaped flow geometry of the respective fluid portion.

24. The diffuser according to claim 21, wherein the vessel inlet is located on the bottom surface of the vessel.

25. A method of treating an aqueous fluid with a fluid reagent comprising:
providing an aqueous fluid stream having at least one contaminant;
effecting a reduction in the fluid pressure of the aqueous fluid stream sufficient to effect a fluid pressure differential between the aqueous fluid stream and a source of a fluid reagent to thereby induce introduction of the fluid reagent from the source of the fluid reagent to the aqueous fluid stream, such introduction of the fluid reagent to the aqueous fluid stream effects reaction of at least a portion of the at least one contaminant in the aqueous fluid stream with at least a portion of the fluid reagent to produce a treated aqueous fluid stream; and
delivering the treated aqueous fluid stream to a motive means, the motive means contributing to effecting the reduction in fluid pressure of the aqueous fluid stream.

26. The method as claimed in claim 25, wherein the reagent includes ozone.

27. A system for treating an aqueous fluid with a fluid reagent comprising:
means for introducing an aqueous fluid stream having at least one contaminant;
means for effecting a reduction in the fluid pressure of the aqueous fluid stream sufficient to effect a fluid pressure differential between the aqueous fluid stream and a source of a fluid reagent to thereby induce introduction of the fluid reagent from the source of the fluid reagent to the aqueous fluid stream, such introduction of the fluid reagent to the aqueous fluid stream effects reaction of at least a portion of the at least one contaminant in the aqueous fluid stream with at least a portion of the fluid reagent to produce a treated aqueous fluid stream; and
a motive means for receiving the treated aqueous fluid stream, the motive means contributing to effecting the reduction in fluid pressure of the aqueous fluid stream.

28. The system as claimed in claim 27, wherein the means for effecting a reduction in the fluid pressure is a venturi-type injector.
